(19) United States
(12) Patent Application Publication
(10) Pub. No.: US 2003/0236895 A1
(43) Pub. Date: Dec. 25, 2003

(54) Method and apparatus for distributing content

(76) Inventors: Keiko Ohkubo, Tokyo (JP); Akemi Sawada, Kokubunji (JP); Yoshihiro Yamada, Kawasaki (JP); Naoki Inaba, Yokohama (JP); Akio Shibata, Matsudo (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/373,043

(22) Filed: Feb. 26, 2003

(30) Foreign Application Priority Data
Jun. 4, 2002 (JP) 2002-162779

(51) Int. Cl. G06F 15/16

(52) U.S. Cl. 709/229

(57) ABSTRACT

A user views contents by a terminal unit at a different place and bit rate in divided times and upon resumption of viewing, and resumed from an end position automatically. A content distribution control server includes a table to record the end position of the content and user ID, content ID and an end position upon interruption of the service. Upon resumption of the service, the end position is retrieved from the table and the content distribution is resumed from the end position. Further, upon resumption of the service, the control server reads in user information (the user position, the terminal unit used, the reproduction software, the bit rate and the like), so that the content distribution service is performed in the condition optimum to user's current utilization environment irrespective of user information used before interruption.

### BACKGROUND OF THE INVENTION

The present invention relates to a content distribution apparatus for distributing a content such as picture, music, game, book and e-Learning in the Internet and more particularly to a content distribution system which can interrupt and resume the content distribution service.

In the content distribution service using the Internet, there are a download type and an upload type. In the download type content distribution service, the user downloads a content into the user's own terminal unit to reproduce the content so that the user makes viewing of the content. In the case of viewing of a charged content, the content can be sometimes reproduced only by a predetermined number of times of reproduction or during a predetermined period of time. In this system, since the content are downloaded into the terminal unit, the user can view the content only by the terminal unit to which the content have been downloaded.

On the other hand, in the streaming type content distribution service, the user can reproduce a content to view the content while receiving the content before downloading all the contents. In this case, the number of times of viewing is decided in some charged contents or the user can view some charged contents many times during a predetermined period of time. In this system, the user often previously designates a reproduction software and a necessary (possible) bit rate and obtains an access right to a streaming file suitable for conditions. Consequently, when the user views a content by the terminal unit, for example, having a picture size different from the size at the beginning of the service, the user cannot obtain optimum picture due to trouble in the bit rate and it is difficult to reproduce the content by any terminal unit. Further, the server always transmits information from the beginning of the content in the streaming type content distribution service and accordingly when the user views one content while dividing the content in several times, the user remembers the end position of the content so as to start the reproduction from the end position at the last time and must set the content at the resumption position by measures such as fast-forwarding means. Accordingly, JP-A-8-292965 has been proposed as the system in which end position is recorded in the user's terminal unit and the end position information is transmitted from the terminal unit to the server upon resumption, so that reproduction is resumed from the end position at the last time automatically. In this system, the user must employ the terminal unit identical with that used before interruption.

### SUMMARY OF THE INVENTION

The prior art has the problem that, even in the streaming type content distribution service, when the user receives the distribution service of content, one terminal unit is dedicated to one content and the user cannot receive the service by any terminal unit. It is an impediment when the user views the content while dividing the content in several times in case where there is a limitation to the number of times of reproduction or the number of reproducible days.

Accordingly, it is an first object of the present invention to permit the user to view a content by a different terminal unit at different place and different bit rate by means of different reproduction software while dividing the content in several times in the content distribution service.

Further, it is a second object of the present invention to reproduce a content from an end position at the last time automatically irrespective of a terminal unit used by the user and a position where the user exists when the user resumes the service after interruption.

Moreover, it is a third object of the present invention to permit each user to resume viewing of a content individually from a respective interruption position at the last time by a different terminal unit at different time and at different place and different bit rate by means of different reproduction software when a plurality of users who view the same content by the same terminal unit at the same time interrupt the viewing of the content and thereafter resume it.

Furthermore, it is a fourth object of the present invention to make it possible to manage end positions of contents in individual unit by means of passwords and individual IDs even in the service that one password such as a group ID is used by a plurality of persons.

In order to solve the above problems, according to the present invention, a content distribution control server is provided on the side of a content service provider and user ID, content ID, an end position and the like are recorded in the distribution control server upon interruption of the service so that the end position is retrieved upon resumption of the service and the content distribution server is resumed from the end position. Further, the content distribution control server selects an optimum distribution server and an optimum streaming file in accordance with a user's current position, a terminal unit used, reproduction software and a bit rate upon start and resumption request of the service from the user to thereby perform the content distribution server.

According to the present invention, the user who receives the content distribution service can view a content by any terminal unit at any place and any bit rate by means of any reproduction software while the same content is divided in any number of times. Further, upon resumption of viewing of the content, the user can view the content from the end position at the last time automatically independent of the used terminal unit and reproduction software.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram of a network illustrating an embodiment according to the present invention in which there is illustrated an example of content distribution service that one user makes start, interruption and resumption of viewing a content;

FIG. 2 is a block diagram illustrating an example of a logical configuration of a content distribution control server used in the embodiment of FIG. 1;

FIG. 3 is a diagram showing an example of a user authentication table used in the content distribution control server of FIG. 2;

FIG. 4 is a diagram showing an example of an optimum server retrieval table used in the content distribution control server of FIG. 2;

FIG. 5 is a diagram showing an example of an end position record table used in the content distribution control server of FIG. 2;

FIG. 6 is a flow chart showing an example of processing of a user's terminal unit upon start, interruption and resumption of the service;

FIG. 7 is a flow chart showing an example of processing of the content distribution control server upon start and resumption of the service;

FIG. 8 is a flow chart showing an example of processing of the content distribution control server upon interruption and end of the service;

FIG. 9 is a flow chart showing an example of processing of the content distribution server upon start, interruption, resumption and end of the service;

FIGS. 10A and 10B are schematic diagrams illustrating a network of a second embodiment according to the present invention in which FIG. 10A illustrates the case where a plurality of users view the content together and FIG. 10B illustrates the case where each user resumes viewing of the content individually after interruption of the distribution;

FIG. 11 is a flow chart showing an example of processing on the side of the user's terminal unit upon start, interruption and resumption of the service when the user has the individual ID;

FIG. 12 is a flow chart showing an example of processing of the content distribution control server upon start and resumption of the service when the user has the individual ID;

FIG. 13 is a flow chart showing an example of processing of the content distribution control server upon interruption and end of the service when the user has the individual ID;

FIG. 14 is a diagram illustrating an example of a configuration of a group member management unit used in the content distribution control server when the user has the individual ID;

FIG. 15 is a flow chart showing an example of processing on the side of the user's terminal unit upon start, interruption and resumption of the service when the user does not have the individual ID;

FIG. 16 is a flow chart showing an example of processing of the content distribution control server upon start and resumption of the service when the user does not have the individual ID;

FIG. 17 is a diagram showing an example of configuration of a group management unit used in the content distribution control server when the user does not have the individual ID;

FIG. 18 is a diagram showing an example of configuration of an end position record table used in the content distribution control server when the user does not have the individual ID;

FIGS. 19A, 19B and 19C are schematic diagrams illustrating a network of a third embodiment according to the present invention in which there is illustrated an example of content distribution service that a plurality of users use one group ID and one user in the group makes start, interruption and resumption of viewing a content and in which FIG. 19A shows a flow of data upon start request of the service, FIG. 19B shows a flow of data upon resumption request by an unjust user and FIG. 19C is a flow of data upon resumption request by a just user;

FIG. 20 is a diagram showing an example of an end position record table used in the third embodiment of FIGS. 19A, 19B and 19C;

FIG. 21 is a flow chart showing an example of processing on the side of the user's terminal unit upon start, interruption and resumption of the service in the third embodiment of FIGS. 19A, 19B and 19C;

FIG. 22 is a flow chart showing an example of processing of the content distribution control server upon start and resumption of the service in the third embodiment of FIGS. 19A, 19B and 19C;

FIG. 23 is a flow chart showing part of processing on the side of the user's terminal unit upon start, interruption and resumption of the service when interrupted contents are managed individually;

FIG. 24 is a flow chart showing part of processing of the content distribution control server upon resumption of the service when interrupted contents are managed individually;

FIG. 25 is a diagram illustrating a fourth embodiment according to the present invention in which the relation of a compressed file and an address correspondence table is shown; and

FIG. 26 is a diagram illustrating another embodiment according to the present invention in which the relation of a compressed file and an address correspondence table is shown.

### DESCRIPTION OF THE EMBODIMENTS

An embodiment of the present invention is now described with reference to the accompanying drawings.

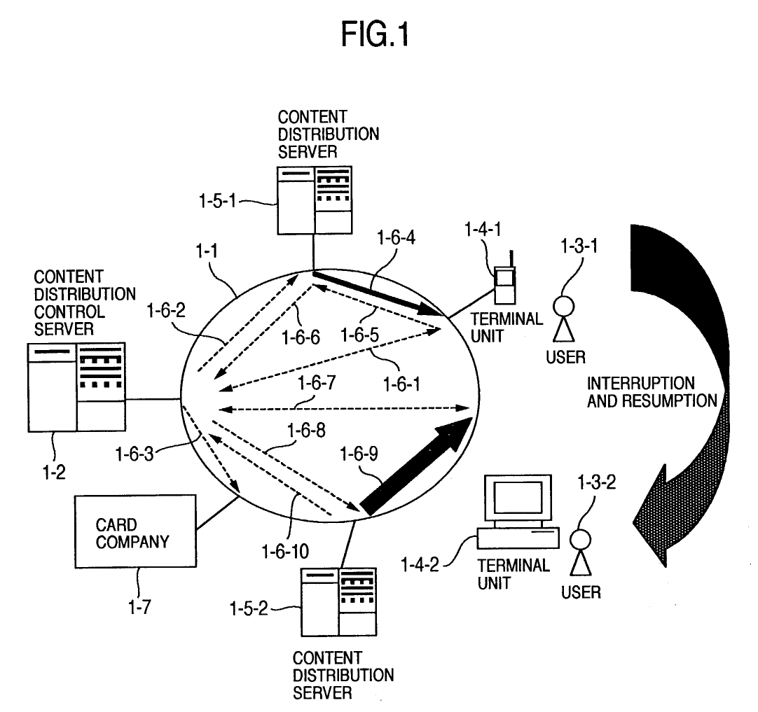

FIG. 1 is a schematic diagram illustrating an embodiment of a system to which the present invention is applied and which is to achieve the first and second objects of the present invention.

Numeral 1-1 denotes a network such as the TCP/IP to which servers and terminal units are connected and numeral 1-2 denotes a content distribution control server provided in a content service provider.

Numerals 1-3-1 and 1-3-2 denote a user 1 at time t1 and t2 (t1<t2), respectively. Numerals 1-4-1 and 1-4-2 denote terminal units used by the user 1 at time t1 and t2, respectively. Numerals 1-5-1 and 1-5-2 denote content distribution servers which distribute (transmit) contents in the streaming manner actually and are operated by content service providers. The content distribution servers 1-5-1 and 1-5-2 distribute the contents such as picture, music, game, book and e-Learning (education using the network). In the streaming type content distribution service, the content transmitted from the distribution server to the terminal unit (computer on the client side) is reproduced in the terminal unit at real time or the user views the content at real time.

It is assumed that the user 1 previously registers himself to the content service provider to receive the service provided by the provider and receives user ID and password from the provider.

Content ID is identification assigned to each distribution data such as work and the same content ID is assigned even to the file having a different compression format if the compressed file is identical with an uncompressed content thereof. However, when the uncompressed content is different from the compressed file even for the same work such as, for example, an English version and a dubbed-in-Japanese version of a movie, the compressed file is assigned with the content ID different from that of the uncompressed file.

Further, it is assumed that the billing method for the service used is previously agreed between the user and the content service provider, so that one billing is made for one content and a bill is transmitted from the content service provider to a card company 1-7. In FIG. 1, the card company 1-7 is a server for making billing and settlement thereof.

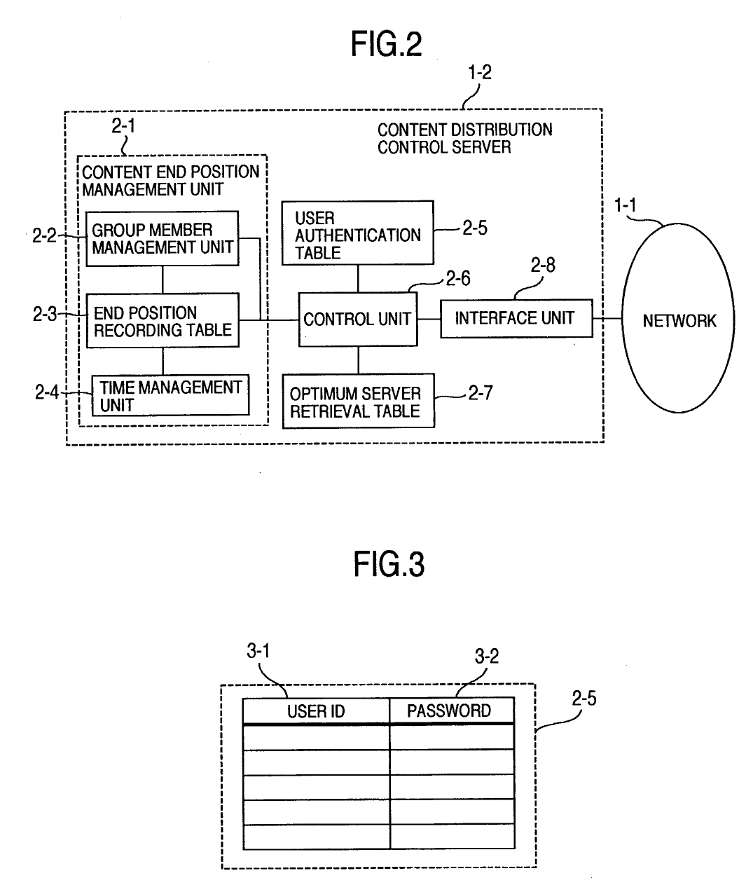

FIG. 2 illustrates a logical configuration of the content distribution control server 1-2.

The content distribution control server 1-2 is composed of a content end position management unit 2-1, a user authentication table 2-5, a control unit 2-6, an optimum server retrieval table 2-7 and an interface unit 2-8.

The content end position management unit 2-1 is composed of a group member management unit 2-2, an end position record table 2-3 and a time management unit 2-4. The interface unit 2-8 is connected to the network 1-1 to send information received from the network 1-1 to the control unit 2-6 and transmits information received from the control unit 2-6 to the network 1-1. Information transmitted and received by the content distribution control server through the network all passes through the interface unit 2-8.

The start procedure of new service is now described with reference to FIGS. 1 and 2. At time t1, the user 1 (1-3-1) transmits the user ID and the password to the content distribution control server 1-2 by means of the terminal unit 1 (1-4-1) to make a login request (1-6-1).

The interface unit 2-8 of the content distribution control server 1-2 which has received the log-in request through the network 1-1 sends the information to the control unit 2-6. The control unit 2-6 sends the user ID and the password to the user authentication table 2-5 to make authentication of the user.

FIG. 3 shows the user authentication table 2-5 in detail.

The user authentication table 2-5 is composed of a user ID column 3-1 and a password column 3-2. The control unit 2-6 notifies the user of permission/rejection of the log-in through the interface unit 2-8 and the network 1-1 in response to the result of user authentication (1-6-1). When the user succeeds in making the log-in operation, the user 1 (1-3-1) transmits the content ID (that is A hereupon) and information of the terminal unit used, a reproduction software used and a necessary bit rate to the content distribution control server to request (1-6-1) start of the content distribution service. In FIG. 1, arrows 1-6-1 to 1-6-10 represent the flow of data.

The control unit 2-6 which has received the request of the content distribution service selects the content distribution server 1-5 optimum to the user from the optimum server retrieval table 2-7 on the basis of the user's current position, the terminal unit used, the reproduction software used, the necessary bit rate and the content ID and sends information of the user ID, the user position, the content ID (content identification), the reproduction software and the necessary bit rate (distribution rate) to the content distribution server (that is the content distribution server (X) 1-5-1 hereupon) to thereby instruct (1-6-2) the content distribution server to distribute the content to the terminal unit 1 (1-4-1) of the user 1 (1-3-1).

Further, a content distribution server located in the position nearest to the geographical condition of the terminal unit utilized by the user is selected as the optimum content distribution server. For example, when the TCP/IP is used as the protocol of the network 1-1, the position (country, prefecture and the like) of the user is decided or identified on the basis of the IP address from the terminal unit and the distribution server located nearest to the terminal unit geographically is selected.

The content distribution control server 1-2 makes settlement (1-6-3) of the content distribution service to the card company 1-7.

The content distribution server (X) 1-5-1 which has received the content distribution instruction from the content distribution control server 1-2 establishes the session between the terminal unit 1 (1-4-1) and the content distribution server and begins to transmit (1-6-4) the required content in a file format according to the reproduction software and the bit rate required by the user. By the foregoing procedure, the user 1 (1-3-1) starts to view the content.

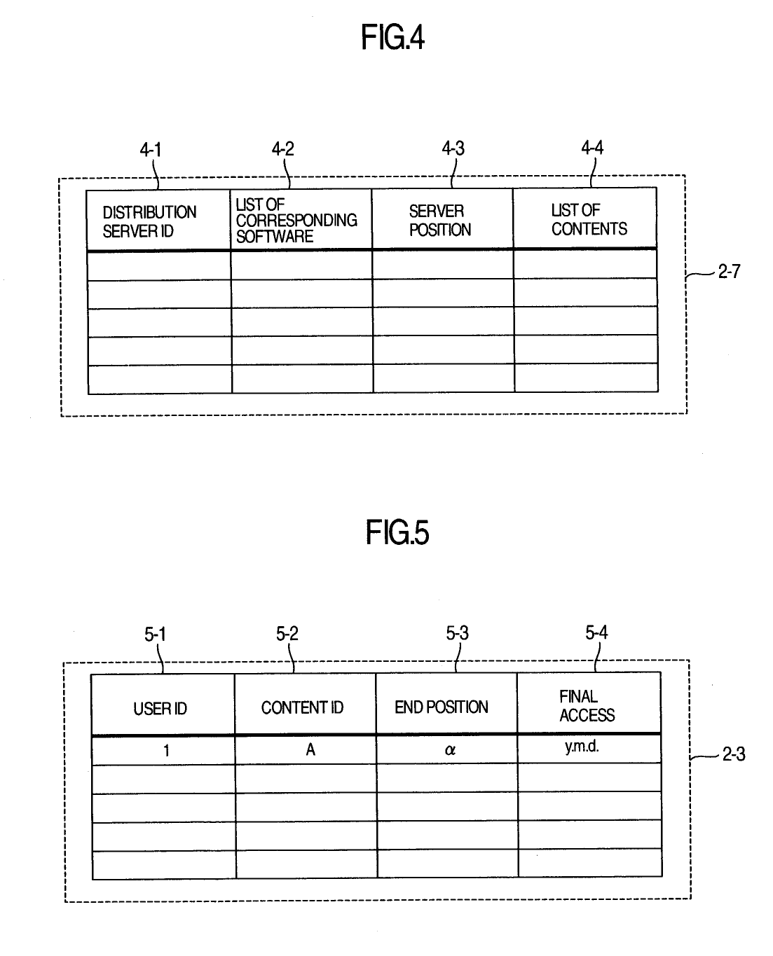

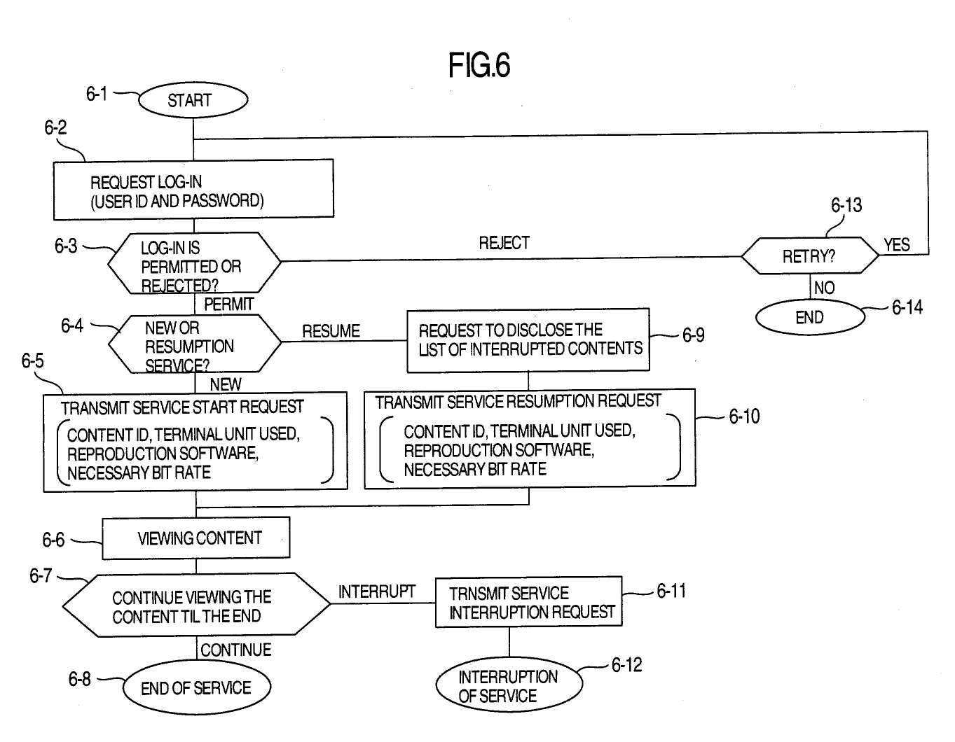

FIG. 4 shows the optimum server retrieval table in detail.

The optimum server retrieval table 2-7 is composed of a “distribution server ID” column 4-1 for recording identification of distribution servers, a “correspondence software list” column 4-2 for recording a list of reproduction software corresponding to the streaming files provided in the distribution servers, a “server position” column 4-3 for recording physical positions of the distribution servers and a “content list” column 4-4 for recording a list of contents provided in the distribution servers

The interruption procedure of the distribution service is now described with reference to FIGS. 1 and 2.

The user 1 (1-3-1) transmits (1-6-5) a content distribution service interruption request to the content distribution server (X) 1-5-1 by means of the terminal unit 1 (1-4-1).

The content distribution server (X) 1-5-1 which has received the content distribution service interruption request interrupts the content distribution and notifies (1-6-6) the user ID (that is 1 hereupon), the content ID (that is A hereupon) and the end position (that is α hereupon) to the content distribution control server 1-2.

The content distribution control server 1-2 which has received the notification obtains the current time (that is y.m.d hereupon) from the time management unit 2-4 and records the current time together with the user ID (1), the content ID (A) and the end position (α) in the end position record table 2-3. When the corresponding data such as the user ID and the content ID are already recorded, the data are updated to new information.

By the foregoing procedure, the content distribution service is interrupted.

FIG. 5 shows the end position record table 2-3 in detail.

The end position record table 2-3 is composed of a “user ID” column 5-1 for recording IDs of the users who are interrupting the content distribution service, a “content ID” column 5-2 for recording IDs of interrupted contents, an “end position” column 5-3 for recording positions at which the users end viewing of the content at the last time and a “final access” column 5-4 for recording the dates (or dates and hours) of final accesses.

The service resumption procedure is now described with reference to FIGS. 1 and 2.

At time t2, the user 1 (1-3-2) uses another terminal unit 2 (1-4-2) put in a place different from the place where the user 1 has newly received the service to transmit the user ID and the password to the content distribution control server 1-2 to thereby make a log-in request (1-6-7).

In the content distribution control server 1-1 which has received the log-in request, the control unit 2-6 sends the user ID and the password to the user authentication table 2-5 to make the user authentication. When the result of authentication is received, the control unit 2-6 notifies permission/rejection of the log-in to the terminal unit 2 (1-4-2). When the log-in is permitted, the user 1 (1-3-2) uses the terminal unit 2 (1-4-2) to request the content distribution control server 2-1 to disclose a list of interrupted contents.

In the content distribution control server 2-1 which has received the disclosure request, the control unit 2-6 retrieves data pertinent to the user 1 from the end position record table 2-3 and transmits the list of interrupted contents to the terminal unit 2 (1-4-2) of the user 1 (1-3-2).

The user 1 (1-3-2) who has received the list of interrupted contents selects a desired content from the list and transmits information of the content ID (A), the terminal unit used, the reproduction software used and the necessary bit rate to the content distribution control server 1-2 to thereby request the resumption of the content distribution service (1-6-7).

The content distribution control server 1-2 which has received the content distribution service resumption request sends the user ID (1) and the content ID (A) to the end position record table 2-3 to retrieve the end position (that is α hereupon) at the last time. Further, the content distribution control server 1-2 selects the content distribution server 1-5 optimum to the user from the optimum server retrieval table 2-7 on the basis of the user's current position, the terminal unit used, the reproduction software used and the necessary bit rate and transmits information of the user ID, the user position, the content ID (A), the reproduction software, the necessary bit rate and the end position (α) to the selected server (that is the content distribution server (Y) 1-5-2 hereupon) to thereby instruct (1-6-8) the server to distribute the content A starting from the end position α to the terminal unit 2 (1-4-2) of the user 1 (1-3-2).

The content distribution server (Y) 1-5-2 which has received the content distribution instruction from the content distribution control server 1-2 establishes the session between the terminal unit 2 (1-4-2) and the server (Y) 1-5-2 and begins to transmit the required content starting from the position α in the file format conformable to the required reproduction software and bit rate (1-6-9). By the foregoing procedure, the user 1 (1-3-2) resumes viewing the content.

Upon the resumption of the content distribution service, the content distribution server 1-2 reloads the user environment (the user position, the terminal unit used, the reproduction software and necessary bit rate) and accordingly the user 1 (1-3-2) can receive the service by means of the terminal unit, the reproduction software and the bit rate different from those used upon the beginning of the service.

Finally, the processing upon completion of the service is described with reference to FIGS. 1 and 2.

The content distribution server (Y) 1-5-2 completes the content distribution to the terminal unit 2 (1-4-2) when the content is ended and transmits the user ID (1) and the content ID (A) to the content distribution control server 1-2. Further, the content distribution server (Y) 1-5-2 notifies the content distribution control server that the content distribution has been completed (1-6-10).

The content distribution control server 1-2 which has received the notification of the content distribution completion sends the user ID (1) and the content ID (A) to the end position record table 2-3 to delete the pertinent data when the data is present.

FIG. 6 is a flow chart showing processing upon start of the distribution service in the user's terminal unit.

In order to begin the content distribution service (6-1), the user inputs the user ID and the password from the terminal unit 1-4-1 or 1-4-2 to be transmitted to the content distribution control server 1-2 to thereby make the log-in request (6-2).

When the log-in is permitted (6-3), it is judged whether it requires a new service or the resumption service (6-4) and when it requires the new service, the user transmits (6-5) the service start request to the content distribution server 1-5-1 or 1-5-2. When the user receives the content, the user begins to view the content (6-6).

When the resumption service is required (64), the user requests to disclose the list of interrupted contents (6-9). The user selects a content from the list disclosed by the content distribution control server and transmits a service resumption request (6-10). When the user receives the content, the user resumes viewing the content (6-6). When the user continues viewing the content till the end (6-7), the service is ended as it is (6-8).

When the viewing of the content is interrupted on the way thereof, the user transmits a service interruption request to the content distribution server (6-11) to thereby interrupt the service (6-12).

When the user authentication is unsuccessful upon the log-in to the content distribution control server 1 and the log-in request is rejected, the log-in request is made again (6-13) or it is ended as it is (6-14).

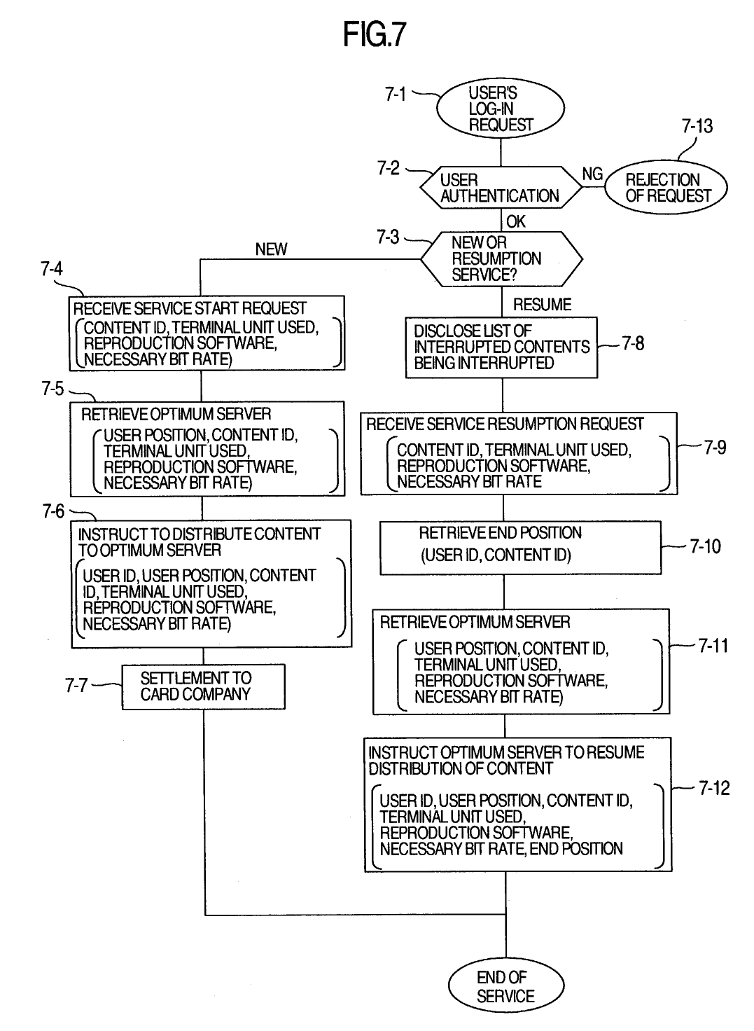

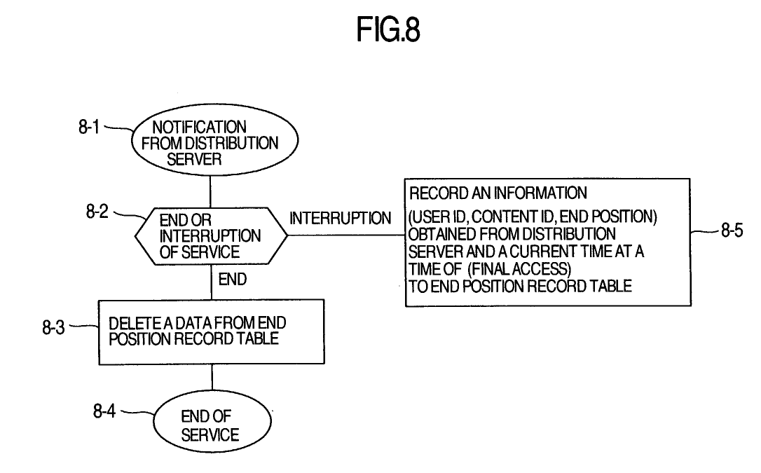

FIG. 7 is a flow chart showing processing of the content distribution control server upon start and resumption of the service.

The content distribution control server receives the log-in request from the user and makes the user authentication (7-2). When the user authentication is successful, the content distribution server continues the processing and when the user authentication is unsuccessful, the server rejects the request and notifies it to the user (7-13).

When the new service is required (7-3), the content distribution control server receives the request information from the user (7-4) and retrieves a server optimum to the content distribution to the user on the basis of the user position, the content ID, the terminal unit used, the reproduction software and the necessary bit rate (6-5). The server instructs to distribute the content to the optimum server selected (7-6). Thereafter, the server makes settlement between the card company 1-7 and the server in accordance with a predetermined procedure (7-7).

When the resumption service is required (7-3), the content distribution control server receives the disclosure request of the list of interrupted contents from the user and retrieves the pertinent interrupted content from the end position record table to notify the retrieved result of the user (7-8).

When the content distribution control server receives the service resumption request from the user (7-9), the server obtains the end position at the last time corresponding to the user and the content ID from the end position record table (7-10) and retrieves the optimum server (7-11). The content distribution control server instructs the selected optimum server to resume the content distribution (7-12).

FIG. 8 is a flow chart showing processing of the content distribution control server upon interruption and end of the service.

The content distribution control server receives notification from the distribution server (8-1) and when it is to notify the end of service (8-2), the server deletes the pertinent data from the end position record table 2-3 (8-3) and the service is ended (8-4).

On the other hand, when interruption is notified (8-2), the content distribution control server records information obtained from the distribution server and the current time in the end position record table 2-3 (8-5). The pertinent data is already recorded, the data is updated.

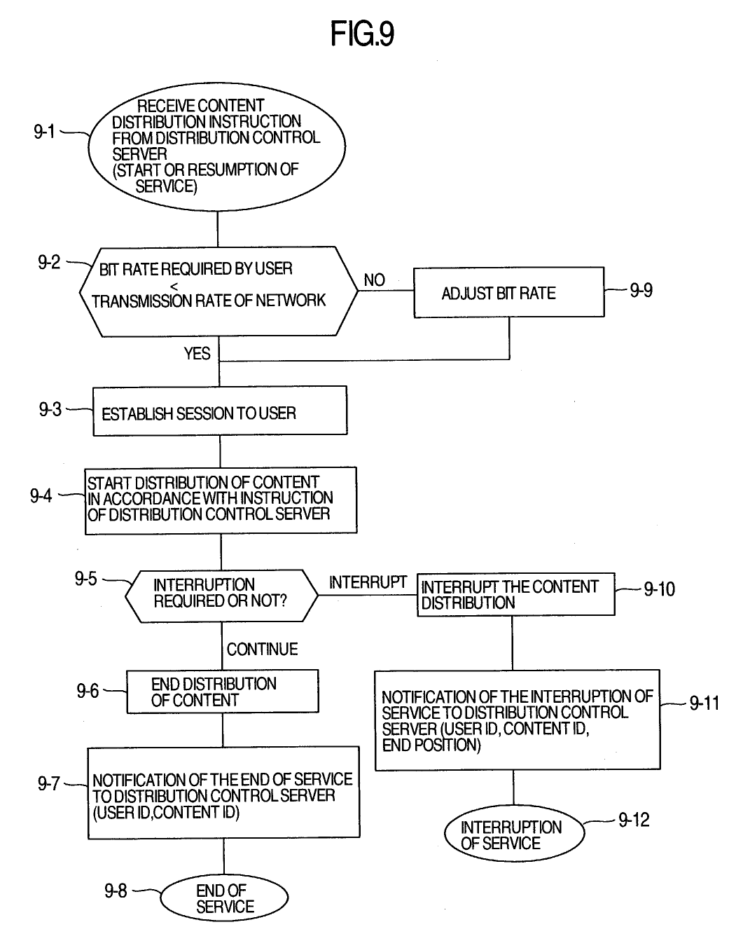

FIG. 9 is a flow chart showing processing of the content distribution server.

When the content distribution server 1-5-1 (or 1-5-2) receives (9-1) the content distribution instruction from the content distribution control server 1-2, the content distribution server compares (9-2) the bit rate required by the user with the distribution rate or speed of the network and when the distribution rate of the network can cover the bit rate required by the user, the content distribution server establishes (9-3) the session to the user.

On the other hand, when the distribution rate of the network cannot cover the bit rate required by the user, the bit rate is changed or adjusted (9-9) to be covered by the distribution rate of the network and the content distribution server establishes (9-3) the session to the user.

When the session is established, the content distribution server starts the content distribution in response to the instruction of the distribution control server (9-4). When the content distribution server receives the interruption request from the user during the content distribution (9-5), the content distribution server interrupts the content distribution and notifies (9-11) the interruption of the service together with the user ID, the content ID and the end position to the distribution control server 1-2 to thereby interrupt (9-12) the service.

When the interruption request is not received during the content distribution (9-5), the content distribution server continues the distribution until the content is ended and when the content distribution is ended (9-6), the content distribution server transmits (9-7) the notification of the end of notification together with the user ID and the content ID to the distribution control server 1-2 to thereby end the service (9-8).

In order to achieve the adjustment (9-9) of the bit rate, there is a method that the content distribution server includes a plurality of files prepared by compressing one content in accordance with a plurality of bit rates and selects a file compressed into a maximum bit rate that does not exceed the distribution rate of the network and the user's request from the plurality of files. Alternatively, there is considered a method (refer to JP-A-2001-333394 “Program Distribution Apparatus, Copy Transfer Apparatus and Copy Transfer Method of Program Data”) that a compressed file constituted by a plurality of streaming types is provided and a streaming type used to transmit the file in accordance with the distribution rate of the network and the user's request is selected.

In the embodiment, by way of example, the user position (geographical condition) is changed greatly has been described, while the embodiment can be applied even within doors. For example, the user who has started the content distribution service by a personal computer put in a living room can interrupt the service to change the room to a bedroom and resume the service by means of an Internet television put in the bedroom in the same manner as above.

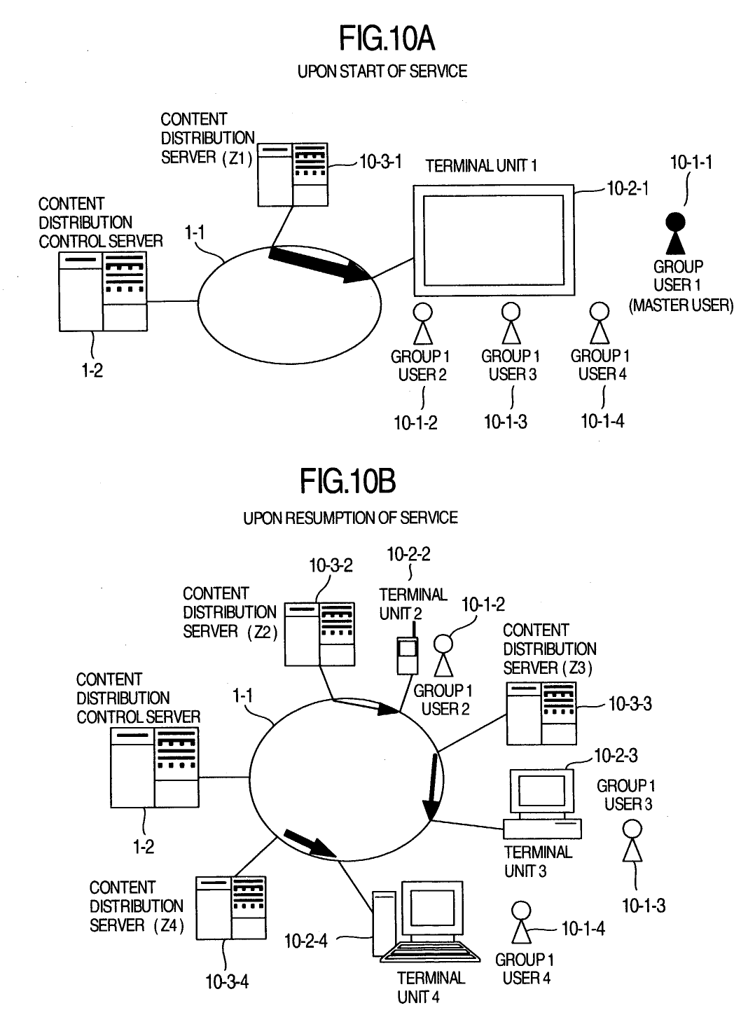

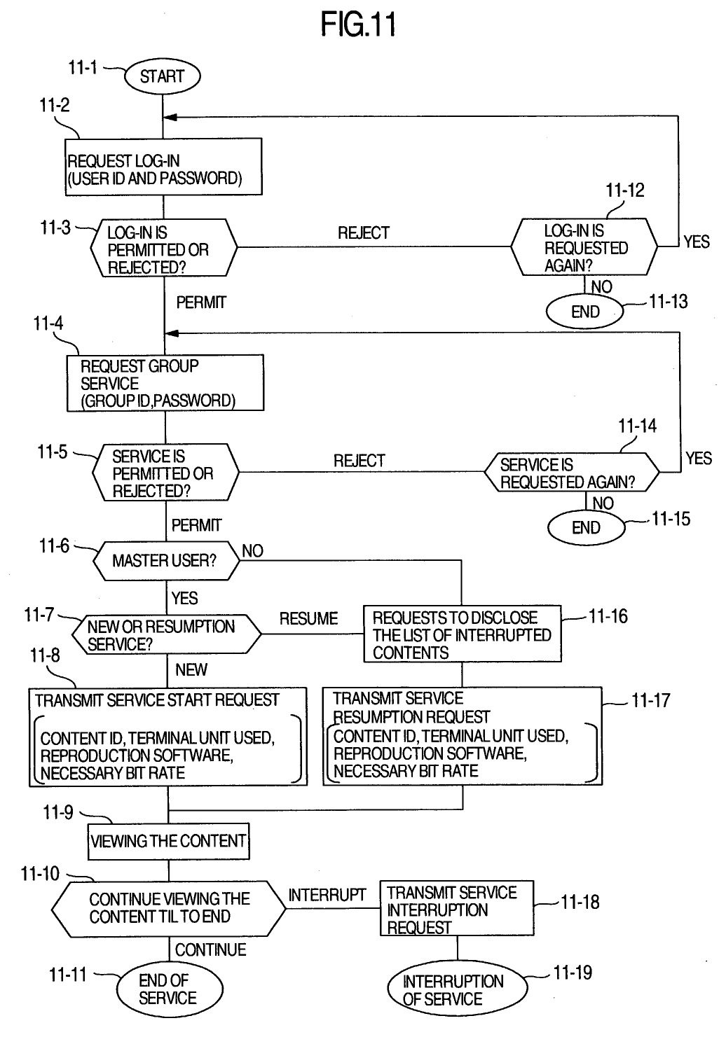

FIGS. 10A and 10B are schematic diagrams illustrating a system (service) according to a second embodiment which is to achieve the third object of the present invention.

Further, FIGS. 10A and 10B show, by way of example, that plural people view the same content by the same terminal unit upon start of the service (FIG. 10A) and each individual person resumes viewing of the content individually after the service is interrupted (FIG. 10B).

Processing flows concerning the user, the content distribution control server and the content distribution server in the second embodiment are substantially identical with the processing flows of the first embodiment, while new functions such as recognition of group, individual passwords in the group, a master user and the like are required.

In the service, each user registers himself as a member in the group previously or upon start of the service.

A case where each member (user) in the group has an individual user ID and a case where each member has only the group ID and an in-group ID is used to identify each individual person are considered. The case where each user has the individual ID and the case where each user does not have it are now described separately while showing respective examples.

<1. Case Where Each User has the Individual ID (Case 1 of the Second Embodiment)>

Each user makes a contract for reception of the service with a content service provider previously. Registration of the group is made upon start of the service or before the start of the service. The content distribution control server 1-2 registers the group ID, the password and a list of members in the group member management unit 2-2 (refer to FIG. 2).

Further, in the embodiment, a master user is established in the group and the content service in group unit is made in accordance with the request from the master user.

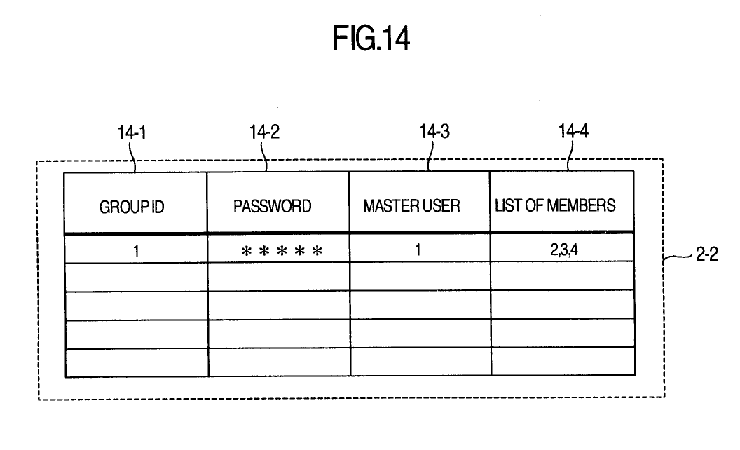

The group member management unit 2-2 also makes registration of the master user. FIG. 14 illustrates the group member management unit 2-2 in detail.

In FIG. 14, the group member management unit 2-2 includes a table composed of a group ID column 14-1 for recording group IDs, a password column 14-2 for recording passwords for the group IDs, a master user column 14-3 for recording master users in respective groups and a list-of-members column 14-4 for recording members in respective groups.

In the embodiment, in FIG. 10A, the user 1 (10-1-1) is registered as the master user of the group 1 and users 2 (10-1-2), 3 (10-1-3) and 4 (10-1-4) are registered as other members of the group 1.

The procedure of starting the service is now described with reference to FIGS. 10A and 10B.

The user 1 (10-1-1) belonging to the group 1 transmits the user ID and the password to the content distribution control server 1-2 by means of the terminal unit 1 (10-2-1) to make a log-in request.

The content distribution control server 1-2 which has received the log-in request makes the user authentication and notifies its result to the user 1 (10-1-1). Then, the user 1 (10-1-1) transmits the group ID and the password to the content distribution control server 1-2 to request the group service. The content distribution control server 1-2 which has received the group service request makes the group authentication and at the same time confirms that the user 1 (10-1-1) is the master user of the group 1 to notify the permission of the group service to the user 1 (10-1-1).

The user 1 (10-1-1) who has received the permission of the group service transmits information of the content ID, the user terminal used, the reproduction software used and the necessary bit rate to the content distribution control server 1-2 to thereby request to start new content distribution service.

The content distribution control server 1-2 which has received the start request of the new content distribution service retrieves an optimum server (that is content distribution server (Z1) 10-3-1 hereupon) from the optimum server retrieval table 2-7 on the basis of the user position, the content ID, the terminal unit used and the reproduction software used and transmits information of the user position, the user ID, the group ID, the content ID, the terminal unit used and the reproduction software used to the content distribution sever (Z1) 10-3-1 to instruct the content distribution sever (Z1) 10-3-1 to distribute the content.

The content distribution server (Z1) 10-3-1 which has received the instruction starts the content distribution service to the terminal unit 1 (10-2-1) in accordance with the instruction.

The procedure of interrupting the service is now described.

The user 1 (10-1-1) transmits the service interruption request to the content distribution server (Z1) 10-3-1 by means of the terminal unit 1 (10-2-1). The content distribution server (Z1) 10-3-1 which has received the interruption request interrupts the content distribution to the terminal unit 1 (10-2-1) and transmits information of the user ID, the group ID and the content ID to the content distribution control server 1-2 to thereby notify the interruption of the service.

The content distribution control server 1-2 which has received the notification of the service interruption confirms that the user 1 (10-1-1) is the master user of the group 1 from the user ID by means of the group member management unit 2-2 and records information (the user ID, the content ID and the end position, and the content ID and the end position are identical for the all the members) of all the members of the group 1 in the end position record table 2-3.

The procedure of resuming the service is now described with reference to FIG. 10B.

The user 2 (10-1-2) transmits the user ID and the password to the content distribution control service 1-2 by means of the terminal unit 2 (10-2-2) to make the log-in request. The content distribution control server 1-2 which has received the log-in request makes the user authentication and transmits the permission of the log-in to the terminal unit 2 (10-2-2) of the user 2 (10-1-2).

The user 2 (10-1-2) which has been permitted to make the log-in transmits the group ID and the password to the content distribution control server 1-2 to request the group service.

The content distribution control server 1-2 makes the authentication by means of the group member management unit 2-2 and notifies the user 2 (10-1-2) of the permission of the service. The user 2 (10-1-2) who has been notified of the permission of the service requests the content distribution control server 1-2 to disclose a list of interrupted contents.

The user 2 (10-1-2) is not the master user and accordingly cannot request the distribution service of a new content as the group service. The content distribution control server 1-2 which has received the disclosure request of the list of interrupted contents transmits the list of interrupted contents of the group 1 to the user 2 (10-1-2).

The user 2 (10-1-2) selects a content from the list transmitted and transmits information of the content ID, the terminal unit used, the reproduction software used and the necessary bit rate to the content distribution control server 1-2 to request the service resumption.

The content distribution control server 1-2 retrieves an optimum server (that is the content distribution server (Z2) 10-3-2 hereupon) from the optimum server retrieval table 2-7 on the basis of the user information and transmits information of the group ID, the user ID, the user position, the terminal unit used, the reproduction software used, the necessary bit rate and the end position at the last time to the content distribution server (Z2) 10-3-2 and transmits an instruction of the content distribution service thereto. The content distribution server (Z2) 10-3-2 starts the content distribution starting from the end position at the last time to the terminal unit 2 (10-2-2) of the user 2 (10-1-2) in response to the instruction from the content distribution control server 1-2.

The users 3 (10-1-3) and 4 (10-1-4) can also resume the content distribution service in accordance with the same processing. The content distribution control server 1-2 makes the resumption of the service individually for each user constituting the group 1 and reloads the individual user environment upon the resumption of the service to select the optimum distribution server and make the content distribution service in the file format conformable to the user's request. Accordingly, the users can resume the service in the environment different from that upon the start of the service and different in each user.

The procedure of requiring the interruption of the service by the users 2 (10-1-2), 3 (10-1-3) and 4 (10-1-4) is substantially identical with the service interruption procedure for the user 1 (10-1-1), while in the update of the end position record tables 2-3 by the content distribution control server 1-2, only the information of the user issuing the interruption request is updated and information of other members in the group is not updated since the users 2 to 4 are not the master user of the group 1.

Further, the procedure at the time that the content is ended is also the same. When the user who has been viewing the content upon end of the content is the user 1 (10-1-1) who is the master user, information of all the users in the group 1 is deleted from the end position record table 2-3, although when the user is not the master user, information except that of the user is not deleted.

Except for the difference between the processing for the master user and the processing for the other users, the processing at the time of ending the service is the same as the processing flow upon the end of the service in the embodiment 1.

FIG. 11 shows a processing flow of user.

The processing flow of FIG. 11 is different from FIG. 6 shown in the first embodiment in that a group service request (11-4, -5, -14, -15) is made and whether a new service is received or not is decided depending on whether the user issuing the request is the master user or not (11-6). Other portion of the flow is the same as the embodiment 1.

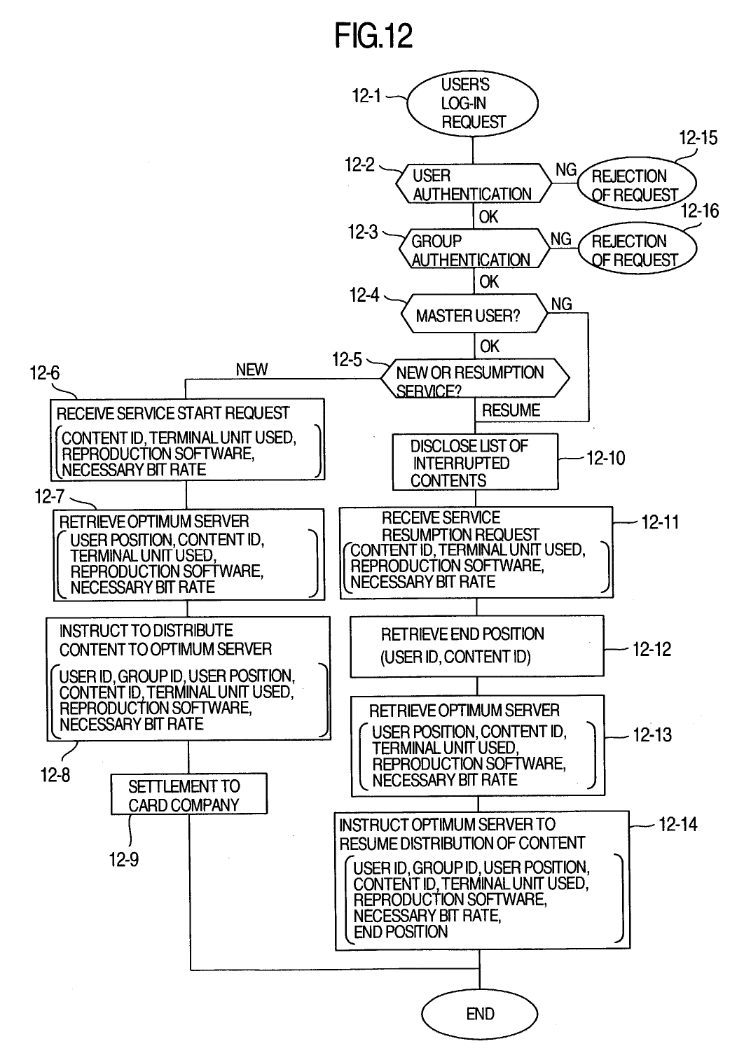

FIG. 12 shows a processing flow of the content distribution control server 1-2 upon start and resumption of the service. The processing flow of FIG. 12 is different from FIG. 7 of the first embodiment in that the group authentication is added (12-3, -16), whether a new service is performed or not is decided depending on whether the user issuing the request is the master user or not (12-4), and the group ID is added to information transmitted and received between the content distribution control server 1-2 and the content distribution servers (12-8, -14). Other portion of the flow is the same as the embodiment 1.

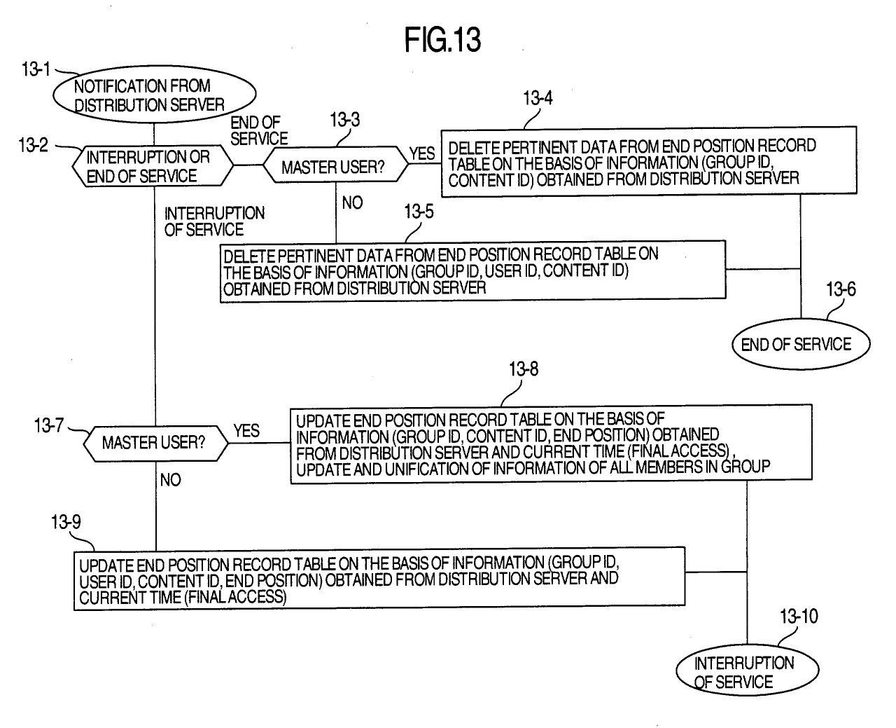

FIG. 13 shows a processing flow of the content distribution control server 1-2 upon end and interruption of the service.

When the user issuing the request is the master user, information of all the members in the group corresponding to the content to be required, of the end position record table 2-3 upon the interruption is updated to be unified (13-8).

Information of all the members in the group corresponding to the required content, of the end position record table 2-3 is deleted upon end of the service (13-4).

When the user issuing the request is not the master user (but the member in the group), only the data for the content to be required by the user is updated (upon interruption of the service) (13-9) or deleted (upon end of the service) (13-5) in the same manner as the embodiment 1.

<2. Case Where the User does not have the Individual ID (Case 2 of the Second Embodiment)>

A contract with the content service provider is made by the group and the individual user makes login by means of the group ID and receives the service. The group authentication is made by means of the group ID instead of the user authentication using the user ID.

Further, the individual users are assigned in-group IDs as identification within the group. The group member management unit 2-2 manages the group IDs, the in-group IDs, the passwords corresponding to the in-group IDs and the passwords for the master users.

In the embodiment, the users 1 to 4 are registered as members of the group 1 and the user 1 is the master user and knows the password for the master user of the group 1.

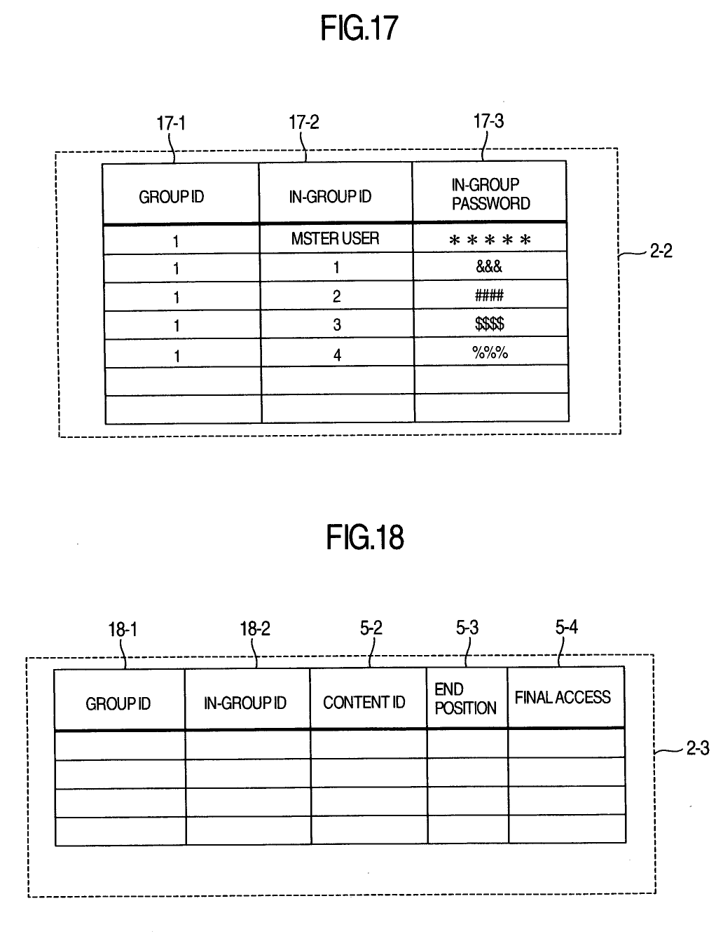

FIG. 17 shows the group member management unit 2-2 in detail.

The group member management unit 2-2 is a table composed of a group ID column 17-1 for recording the group IDs, an in-group ID column 17-2 for recording the IDs within the group, and an in-group password column 17-3 for recording the passwords corresponding to the in-group IDs.

The procedure of starting the service is now described with reference to FIGS. 10A and 10B.

The user 1 (10-1-1) transmits the group ID and the password to the content distribution control server 1-2 by means of the terminal unit 1 (10-2-1) to make the log-in request. The content distribution control server 1-1 which has received the request makes the group authentication and transmits its result to the terminal unit 2 (10-2-1) of the user 1 (10-1-1). When the user 1 (10-1-1) is permitted by the content distribution control unit 1-2 to make the log-in, the user notifies to the content distribution control server that the user is the master user and inputs the password of the master user.

The content distribution control server 1-2 which has received the inputted password confirms the password and notifies the user 1 (10-1-1) of its result. When the user 1 (10-1-1) is authenticated as the master user, the user transmits information of the content ID, the terminal unit used, the reproduction software and the necessary bit rate to the content distribution control server 1-2 to request the server 1-2 to start the service. The content distribution service is started by the same processing as the case 1 of the embodiment 2.

However, the content distribution control server 1-2 transmits the in-group ID to the content distribution server (Z1) 10-3-1 instead of the user ID. Hereupon, since the user 1 (10-1-1) is the master user, the master user ID is transmitted as the in-group ID.

The interruption processing of the service is now described.

The user 1 (10-1-1) transmits an interruption request to the distribution server (Z1) 10-3-1 by means of the terminal unit 1 (10-2-1). The distribution server (Z1) 10-3-1 which has received the interruption request interrupts the content distribution service to the user 1 (10-1-1) and transmits information of the group ID, the in-group ID (master user), the content ID and the end position to the content distribution control server 1-2 to notification of the interruption of the service to the server 1-2. Since the user issuing the service interruption request is the master user, the content distribution control server 1-2 which has been notified the service interruption adds information of the content ID and the end position in the end position record table 2-3 as information for all the members in the group 1.

In order to realize the service, the end position record table 2-3 includes a group ID column 18-1 and an in-group ID column 18-2 instead of the user ID column 5-1 shown in FIG. 5 (refer to FIG. 8).

The resumption processing of the service is now described.

In FIG. 10B, the user 2 (10-1-2) transmits the group ID and the password to the content distribution control server 1-2 by means of the terminal unit 2 (10-2-2) to make a log-in request. The content distribution control server 1-2 makes the group authentication and transmits its result to the user 2 (10-2-2). When the log-in is permitted, the user 2 (10-2-2) requests the content distribution server 1-2 to disclose the interrupted contents since the user 2 (10-2-2) is not the master user.

When the user 2 (10-2-2) selects a content, the user transmits information of the in-group ID, the in-group password, the content ID, the terminal unit used, the reproduction software and the necessary bit rate to the content distribution control server 1-2 to request the server to resume the content distribution service. The content distribution control server which has received the request confirms the in-group ID and the in-group password by means of the group member management unit 2-2. When the password is coincident, the content distribution control server obtains the end position of the pertinent data from the end position record table 2-3 and retrieves the optimum server. Then, the same processing as the case 1 of the second embodiment is performed to thereby resume the service. However, the in-group ID is used instead of the user ID, of the information from the content distribution control server 1-2 to the content distribution server (Z2) 10-3-2.

The interruption and the end processing of the service by the group member who is not the master user and the end processing of the service by the master user are performed by the same processing as the case 1 of the embodiment 2.

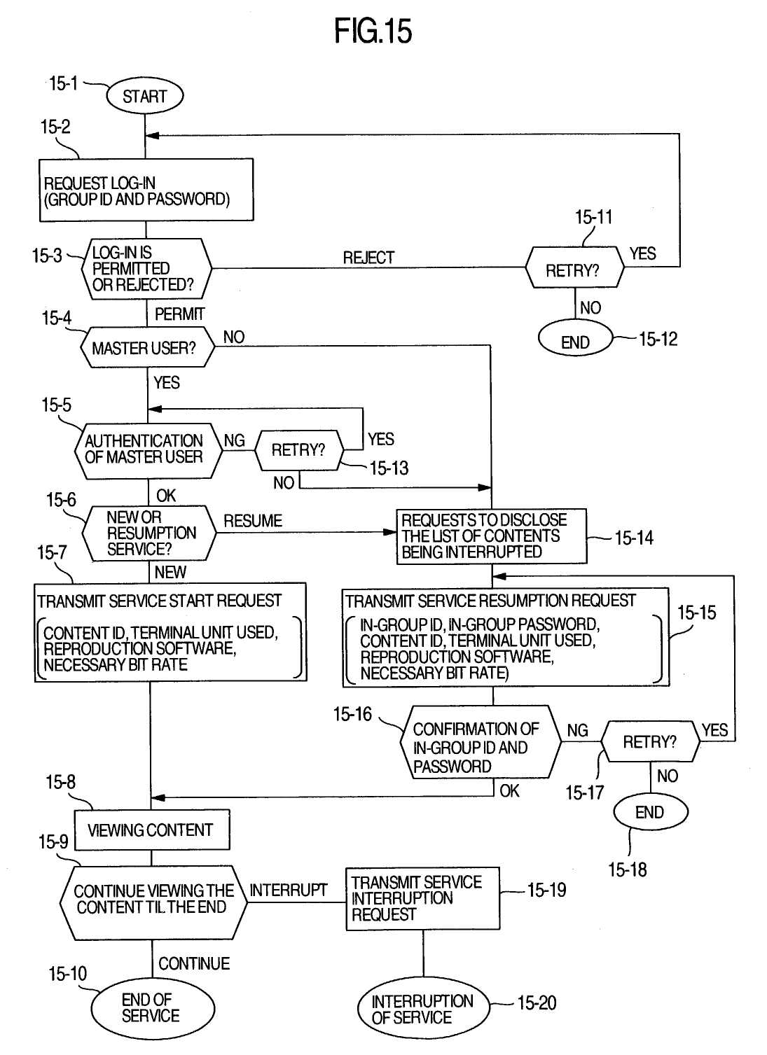

FIG. 15 shows a processing flow performed by the user's terminal unit. The processing flow of FIG. 15 is different from FIG. 6 shown in the first embodiment in that the log-in is made by the group ID (15-2), the master user is authenticated (15-4, -5, -13) and the in-group ID and the in-group password are transmitted (15-15) upon resumption request of the service to examine the password (15-16, -17, -18).

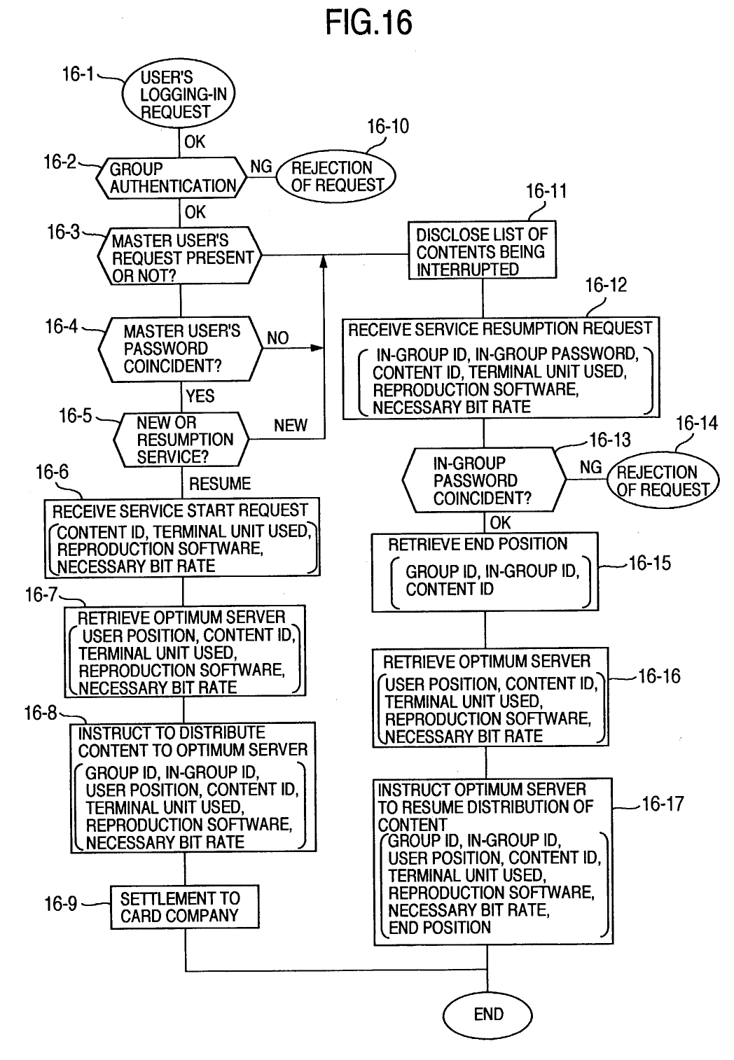

FIG. 16 shows a processing flow upon start and resumption of the service by the content distribution control server 1-2. The processing flow of FIG. 16 is different from FIG. 7 shown in the first embodiment in that the user authentication of the login is made by the group ID (16-2), the master user is authenticated (16-3, -4), the in-group ID and the password are confirmed upon the resumption request of the service (16-13, -13, -14), and the group ID and the in-group ID are transmitted instead of the user ID when the content distribution server is instructed to make distribution (16-8, -17).

As an example of the cases 1 and 2 of the embodiment 2, application of the service to an educational institution is considered. As shown in FIG. 10A, all of trainees view a content displayed at a large screen (10-2-1) in educational facilities by means of a lecturer's (master user's) operation upon start of the service. At this time, the content is provided by a streaming file having a high bit rate suitable to the large screen.

Thereafter, when each trainee (member of group) resumes the viewing of the content from the interruption position, the content is provided in the streaming file compressed to a format suitable for the screen size, the network and the reproduction software used by each trainee in accordance with the environment of each trainee. Consequently, each trainee can receive the satisfactory service suitable for the individual environment even in the educational facilities and even in another place such as home.

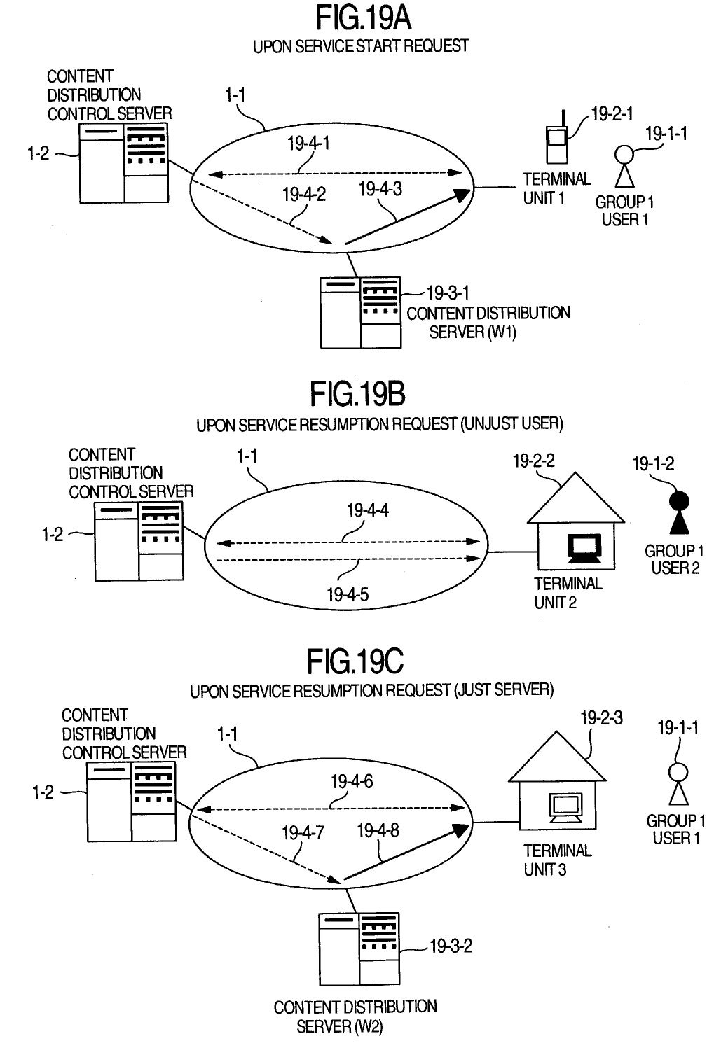

FIGS. 19A to 19C are schematic diagrams illustrating a system according to a third embodiment which is to achieve the fourth object of the present invention.

There is considered the service that one group ID is shared by plural people and each member in the group can receive the service of viewing the content.

In the service, in order to prevent viewing of a interrupted content of a certain member in the group from being resumed unjustly by another member in the group, a password for resumption of the service is established.

Two examples of establishing the password in accordance with designation by the user and in accordance with designation from the content distribution control server are now described.

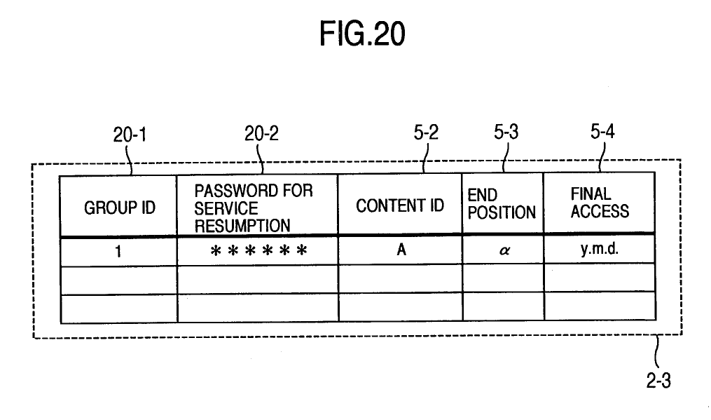

As shown in FIG. 20, the end position record table 2-3 includes a group ID column (20-1) and a service resumption password column (20-2).

<3-1. The User Establishes the Password upon Start of the Service>

The procedure upon start of a new service is described with reference to FIGS. 19A to 19C.

The user 1 (19-1-1) transmits the group ID and the password to the content distribution control server 1-2 by means of the terminal unit 1 (19-2-1) to make a log-in request (19-4-1).

The content distribution control server 1-2 makes the group authentication and notifies the user 1 (19-1-1) of its result. When the log-in is permitted, the user 1 (19-1-1) transmits information of the content ID, the terminal unit used, the reproduction software, the necessary bit rate and the password for resumption to the content distribution control server 1-2 to request start of the service. The content distribution control server 1-2 which has received the service start request records the user ID, the content ID and the password for resumption in the end position record table 2-3. Then, the same procedure as the embodiment 1 is performed to thereby start the content distribution service.

The processing procedure upon the service resumption request by an unjust user is shown in FIG. 19B. The user 2 (19-1-2) transmits the group ID and the password to the content distribution control server 1-2 by means of the terminal unit 2 (19-2-2) to make a log-in request.

The content distribution control server 1-2 makes the group authentication and notifies the user 2 (19-1-2) of its result. When the log-in is permitted, the user 2 (19-1-2) requests the content distribution control server 1-2 to disclose a list of interrupted contents and selects a content to transmit the content ID thereof to the content distribution control server 1-2 (19-4-4).

At this time, since the user 2 (19-1-2) is not the just user, the user 2 does not transmit the password for resumption or transmits a wrong password. The content distribution control server 1-2 examines the password for resumption by means of the end position record table 2-3 and notifies the user 2 (19-1-2) that the resumption of the service is not permitted due to disagreement of the password (19-4-5).

The processing procedure upon the service resumption request by the just user is shown in FIG. 19C. The user 2 (19-1-1) transmits the group ID and the password to the content distribution control server 1-2 by means of the terminal unit 3 (19-2-3) to make a log-in request. The content distribution control server 1-2 makes the group authentication and notifies the user 1 (19-2-1) of its result. When the user 1 (19-1-1) is notified that it is successful, the user requests the content distribution control server 1-2 to disclose a list of interrupted contents and selects a content. The user transmits the content ID and the password for resumption to the content distribution control server to request the service resumption. The content distribution control server 1-2 which has received the service resumption request examines the password for resumption by means of the end position record table 2-3 and when the password is authorized, the service is resumed in accordance with the same procedure as the embodiment 1.

The processing upon interruption and end of the service is performed in accordance with the same procedure as the embodiment 1. However, the group ID is used instead of the user ID.

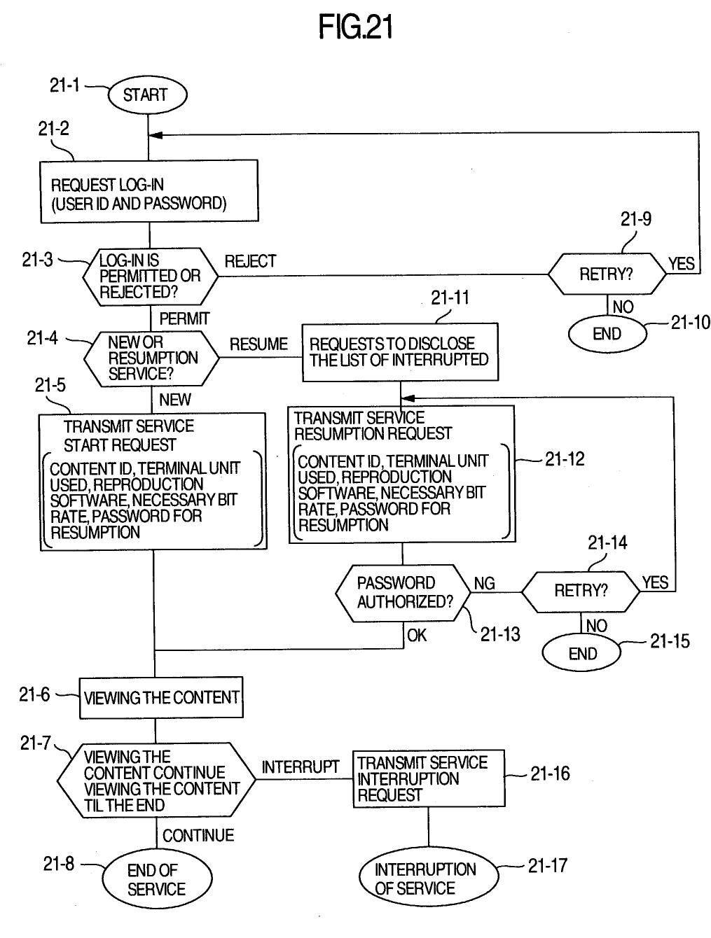

FIG. 21 shows a processing flow made by the user's terminal unit.

The processing flow shown in FIG. 21 is different from FIG. 6 shown in the first embodiment in that the group ID is transmitted instead of the user ID upon the log-in (21-2), the password for resumption is designated upon start of the service (21-5), and the password for resumption is transmitted (21-12) upon the service resumption request to take an examination of the password (21-13, -14, -15).

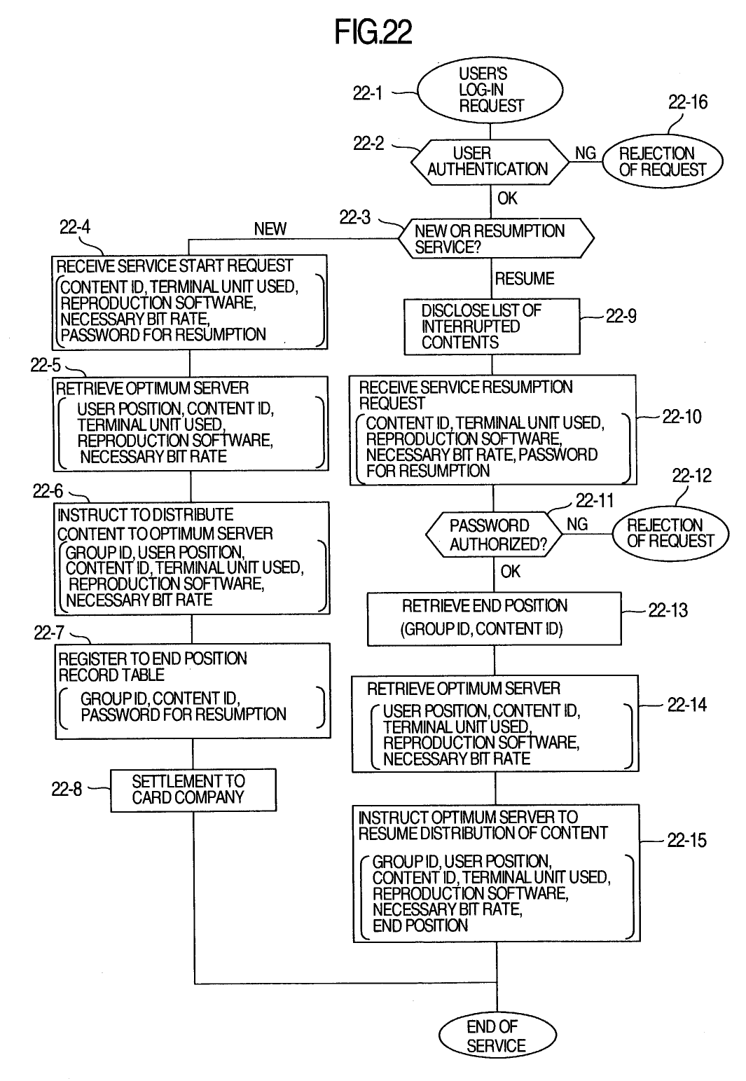

FIG. 22 shows a processing flow upon start and resumption of the service by the content distribution control server.

The processing flow shown in FIG. 22 is different from FIG. 7 shown in the first embodiment in that the password for resumption is designated by the user upon start of the service (22-4), the group ID is used instead of the user ID, and the group ID, the content ID and the password for resumption are recorded in the end position record table 2-3 upon start of the service (22-7).

<3-2. Case Where the Content Distribution Control Server Designates the Password>

The procedure of starting a new service is described. The procedure is substantially the same as the above case 3-1, while the password for resumption is not contained in the service start request from the user 1 (19-1-1) and the content distribution control server 1-2 which has received the service start request delivers the password for resumption to the user 1.

The delivery of the password for resumption is made by receiving the password for resumption between steps 21-5 and 21-6 in the processing flow of the user of FIG. 21 and delivering the password for resumption between steps 22-4 and 22-5 in the processing flow of the content distribution control server of FIG. 22.

<3-3. Case Where the Password is Established upon Interruption of the Service>

In the above cases 3-1 and 3-2, the password for resumption is established upon start of the service, while the password can be designated by the user upon interruption of the service or the content distribution control server can deliver the password.

In this case, when the user designates the password, the password for resumption is also designated at the same time when the service interruption request is transmitted to the content distribution server and the password for resumption is also notified to the content distribution control server together with the group ID, the content ID and the end position when the content distribution server notifies the service interruption to the content distribution control server. The content distribution control server which has received the notification records the information in the end position record table 2-3.

Further, when the content distribution control server 1-2 designates the password, the content distribution server which has received the service interruption request from the user transmits the user position together with the user ID, the content ID and the end position to the content distribution control server and the content distribution control server which has received the notification delivers the password for resumption to the user and records it together with the information obtained from the content distribution server in the end position record table 2-3.

<3-4. Individual Management of Interrupted Contents>

In the examples of the above cases 3-1 to 3-3, the list of interrupted contents is the list of interrupted contents of all the members in the group, while the password for resumption is inputted upon the disclosure request of the list of interrupted contents to thereby retrieve only items conformable to the group ID and the password for resumption, so that the list of only interrupted contents of the user who made the request is provided.

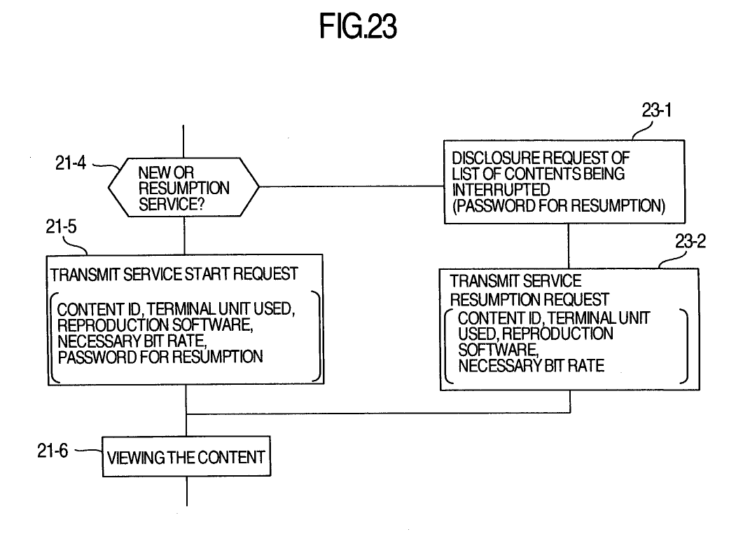

FIG. 23 shows a processing flow made by the user's terminal unit.

The processing flow is substantially the same as FIG. 21 and FIG. 23 shows only portions different from FIG. 21.

Upon resumption of the service, the user transmits the password for resumption together with the disclosure request of the list of interrupted contents (23-1). When the user receives pertinent data disclosed, the user selects a content and transmits the service resumption request (23-4).

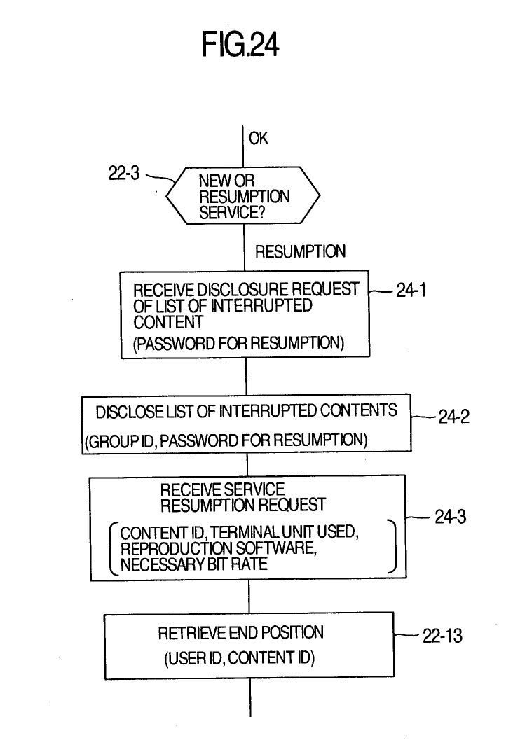

FIG. 24 shows a processing flow of the content distribution control server.

The processing flow of FIG. 24 is substantially the same as FIG. 22 and FIG. 24 shows only portions different from FIG. 22.

When the request service is resumed (22-3), the password for resumption is also received (24-1) at the same time upon reception of the disclosure request of the list of interrupted contents and accordingly only data having the coincident group ID and password for resumption are disclosed (24-3) to the user from the end position record table 2-3. When the service resumption request is received (24-3) from the user, the end position is retrieved and then the processing of steps 22-14 and 22-15 is performed.

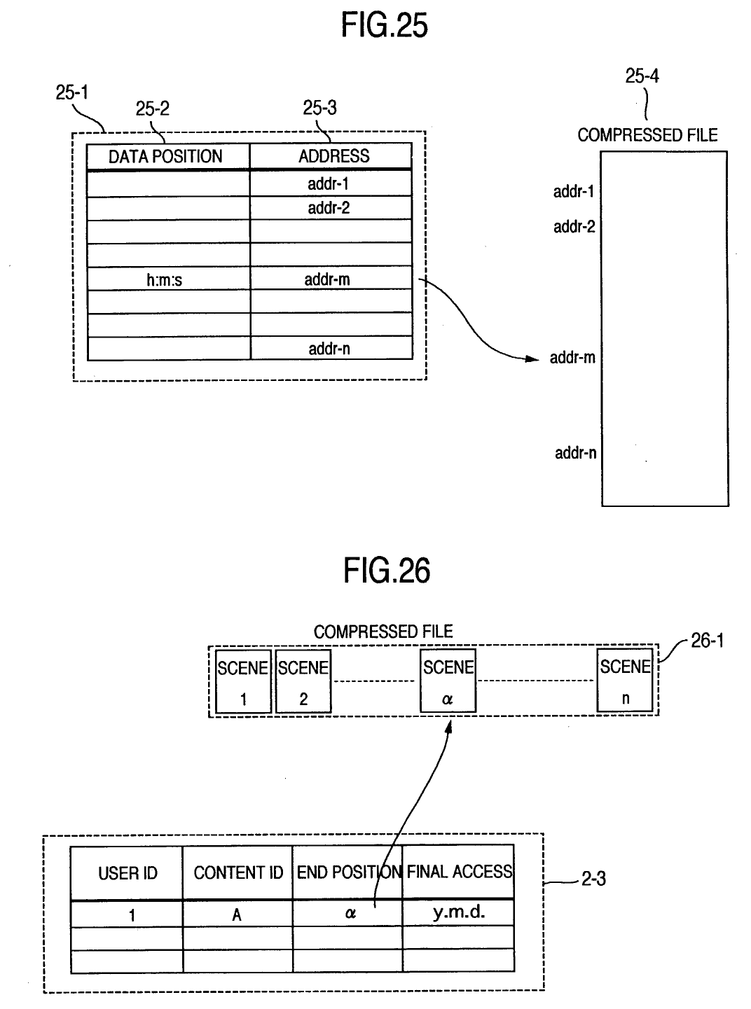

FIG. 25 illustrates a fourth embodiment showing an example of a data format of the end position used in the first to third embodiments.

The content distribution server 1-5-1 transmits time (hour: minute: second, that is expressed by h:m:s hereupon) from a start point to an interruption point of time of the content as the end position to the content distribution control server 1-2 and the content distribution control server 1-2 records the time h:m:s as the end position in the end position record table 2-3.

Upon the resumption of the service, the distribution server 1-5-2 calculates a start address (addr-m) of transmission from the correspondence table of data positions and addresses on the basis of the content ID (A), the reproduction software (S1), the bit rate (B1) and the end position (h:m:s) transmitted from the distribution control server 1-2 and starts to transmit the content from the address addr-m.

FIG. 25 shows the address correspondence table and a compressed file provided in the content distribution server. Numeral 25-1 denotes the address correspondence table including a data position column 25-2 and an address column 25-3. Hereupon, the address correspondence table 25-1 represents the address table corresponding to the content A, the reproduction software S1 and the bit rate B1.

The content distribution server 1-5-2 retrieves the address addr-m from the address correspondence table 25-1 on the basis of the data position h:m:s and starts to transmit a compressed file from the address addr-m. The address position 25-2 of the address table 25-1 is recorded at intervals of 10 seconds, for example, and an address at a maximum data position within the data position h:m:s is retrieved upon the retrieval of the address.

In a fifth embodiment, a time code is used as the end position.

The time code includes information of hour: minute: second: and a frame number (position information of the content).

The frame number depends on the frame rate. For example, a value of 0 to 29 is recorded as the frame number for the frame rate of 30 (30 frames/second) and a value of 0 to 23 is recorded for the frame rate of 24. However, when the frame rate required by the user is different before and after the interruption, the frame number is sometimes invalid.

Streaming information containing the compression type, the frame rate, the number of pixels and the like is added in the end position record table. When the service is interrupted, the streaming information used before the interruption is recorded in the table. The recorded streaming information is compared with a new streaming information upon resumption. When both are coincident, the end position information to the frame number is used and when both are different, the end position information to hour: minute: second is used.

In a sixth embodiment, a position slightly before the end position at the last time is set as the resumption position upon resumption of the service in the first to third embodiments, so that the user remembers the contents at the last time easily. The processing procedure thereof is described with reference to FIG. 1.

When the content distribution server 1-5 makes processing of service in accordance with the interruption request from the user 1 (1-3-1), a position returned by a fixed time from the actual end position is notified to the content distribution control server 1-2 as the end position.

The content distribution control server 1-2 records the notified end position in the end position record table 2-3. Alternatively, the content distribution server 1-5-1 notifies the actual end position to the content distribution control server 1-2. The content distribution control server 1-2 which has been notified the actual end position records a position returned by a fixed time from the notified end position in the end position record table 2-3. The processing flow except for the recording of the end position in the end position record table 2-3 is the same as the embodiment 1.

The position returned by the fixed time from the actual end position is recorded as the end position recorded in the end position record table 2-3 by any of the above-mentioned methods and upon resumption of the service the content is distributed from the recorded end position so that the content can be reproduced from the position returned by the fixed time from the end position at the last time.

In a seventh embodiment, an actual end position is recorded instead of the position returned by the fixed time from the actual end position, which is recorded as the end position in the end position record table 2-3 in the sixth embodiment, and upon resumption of the service the content is distributed from the position returned by the fixed time from the recorded end position, so that the content can be reproduced from the position returned by the fixed time from the end position at the last time. The processing procedure thereof is described with reference to FIG. 1.

In interruption of the service, the content distribution control server 1-2 records the actual end position in the end position record table 2-3. When the content distribution control server 1-2 receives the service resumption request from the user 1 (1-3-2), the content distribution control server notifies the position returned by the fixed time from the end position recorded in the end position record table 2-3 to the content distribution server 1-5-2. The content distribution server 1-5-2 distributes the content from the notified end position. Alternatively, when the content distribution control server 1-2 receives the service resumption request from the user 1 (1-3-2), the content distribution control server notifies the end position recorded in the end position record table 2-3 to the content distribution server 1-5-2. The content distribution server 1-2 distributes the content from the position returned by the fixed time from the notified end position. The processing except for that concerning the end position upon resumption of the service is the same as the embodiment 1.

In an embodiment, the end position at the last time or the position returned from the end position at the last time can be selected as the resumption position of the service in response to the request from the user.

The processing procedure thereof is described with reference to FIG. 1. The processing of the start to the interruption of the service is the same as the embodiment 1. The user 1 (1-3-2) issues a returning request from the end position at the last time together with the service resumption request upon resumption of the service. Since the returning request from the end position is contained in the service resumption request, the content distribution control server 1-2 notifies the position returned from the end position recorded in the end position record table as the end position to the content distribution server 1-5-2. The content distribution server 1-5-2 distributes the content from the notified end position. The processing except for that concerning the notification of the end position upon resumption of the service is the same as the embodiment 1.

In a ninth embodiment, when the user interrupts and resumes the service plural times, a new end position is prevented from being returned or set before as compared with the resumption position of the content distribution (the end position of the content distribution at the last time).

The processing procedure thereof is described with reference to FIGS. 1 and 2.

After the resumption of the server, when the end position upon re-interruption of the service is returned before as compared with the resumption position of the content distribution (the end position of the service at the last time) by returning operation of the user 1 (1-3-2), the content distribution control server 1-2 which has been notified the end position from the content distribution server 1-5-2 does not update the end position record table 2-3.

In the processing flow of the content distribution control server, the end position (the end position at the last time) recorded in the end position record table 2-3 is compared with the end position (the end position at this time) obtained from the distribution server and a position nearer to the end of the content is recorded in the end position record table 2-3 as a new end position.

In a tenth embodiment, the content distribution control server 1-2 deletes from the end position record table 2-3 the content left interrupted without utilization as the service and to which the user does not access for a fixed period.

The processing procedure is described with reference to FIG. 2. The time management unit 2-4 retrieves the end position record table 2-3 at predetermined intervals and deletes from the end position record table 2-3 the information having the time between the current time and the time recorded in the final access column 5-4 exceeding a predetermined number of days.

In an eleventh embodiment, as shown in FIG. 26, one file is subdivided by the scene, for example, to be stored as streaming files 26-1 and each files are assigned sequential numbers 1˜α˜n. The end position in the end position record table 2-3 is managed by the sequential number of the streaming files. The streaming files are transmitted successively in accordance with the sequential number from the scene 1 upon start of the service and from the scene α of the end position at the last time upon resumption of the service to thereby attain the start, the interruption and the resumption of the service of the first to third embodiments.

As described above, according to the present invention, by comprising the plurality of content distribution servers 1-5-1 and 1-5-2, the end position record table 2-3 and the optimum server retrieval table 2-7 in the streaming the content distribution through the network, the user can automatically resume reproduction (or viewing) of the content from the end time at the last time (or the predetermined time before the end time) by any terminal unit at any place and any bit rate (distribution rate) by means of any reproduction software, so that the freedom degree of content distribution and reception of the streaming type can be increased and particularly convenience can be afforded to the user who receives the content having the limitation in the viewing period, so that the charged streaming type content distribution service can be all the more spread.

Further, the current time is recorded together with user information at the time that the distribution interruption request is received from the terminal unit and thereafter when the distribution resumption request is not received from the user within a predetermined period, the recorded information may be deleted.

Billing is not performed at the time that the distribution resumption request of the content is received and distribution control means may comprise billing processing or billing means for performing predetermined billing processing at the time that the distribution start request of the content is received.

Further, a plurality of users are assigned one group ID and password and the authentication is made by means of the group ID. A predetermined member of the group members requests to start the content distribution and thereafter in order to prevent that distribution resumption of the content is performed by another member of the same group during the interruption of the service when the distribution service is interrupted, there may comprise authentication processing or authentication means for issuing a password for content distribution resumption to the predetermined member upon start or interruption of the distribution and authenticating individual user by authentication of the password upon distribution resumption of the content.

Furthermore, instead of issuing the password for content distribution resumption by the content distribution control server, there may comprise authentication means or authentication processing for causing the user himself to establishing the password upon start or interruption of the content distribution.

Instead of the content distribution control server, the content distribution server may issue the password for content distribution resumption upon start or interruption of the distribution and notify the password to the content distribution control server.

Further, there may comprise authentication processing or authentication means for recording the user IDs for individual users in response to the user's declaration and issuing the password for distribution resumption for each user ID by the content distribution server so that the password is examined upon content distribution resumption to thereby confirm that the user is the true user for resumption.

Moreover, instead of issuing the password for content distribution resumption by the content distribution control server, the content distribution server may issue the password and notify the password to the content distribution control server.

Further, instead of issuing the password for content distribution resumption by the content distribution control server, there may comprise password establishing means (or password establishing processing) for allowing the individual user to designate the password.

Further, there may comprise password establishing means (or password establishing processing) for defining or deciding the password for content distribution resumption of each user by designation of the user himself or by designation from the content distribution control server.

Furthermore, the content distribution control server may comprise billing means or billing processing for making billing for each user ID recorded upon start or interruption of the distribution.

Further, instead of making billing upon start or interruption of the distribution, there may comprise billing means or billing processing for making billing individually when each user resumes the service.

Further, there may comprise interrupted content disclosure means or processing for managing interrupted contents for each user by the content distribution control server and disclosing a list of interrupted contents of the user in response to the user's distribution resumption request.

Furthermore, there may comprise interrupted content disclosure means or processing which, when a plurality of users receive the distribution resumption service in group unit by means of one group ID, manages interrupted contents for individual users in the group and providing passwords for individual users in the group individually to thereby disclose only the interrupted contents of the user himself by means of examination of the password in response to a disclosure request of a list of interrupted contents of the user.

Further, when the content is interrupted at the position returned before as compared with the resumption position by means of the user's operation after resumption of the distribution again, the new end position may be made void and the position upon the resumption of the distribution may be recorded as the end position.

In the embodiment, the optimum distribution server is selected on the basis of the geographical condition, although the present invention is not limited thereto and the distribution server may be decided on the basis of the congestion or traffic of the network between the terminal unit and the distribution server or on the basis of the transmission capacity of the network between the terminal unit and the distribution server.

It should be further understood by those skilled in the art that although the foregoing description has been made on embodiments of the invention, the invention is not limited thereto and various changes and modifications may be made without departing from the spirit of the invention and the scope of the appended claims.

1. A content distribution method of distributing a content to a terminal unit through a network, comprising:
distribution start processing of distributing the content in response to a distribution start request received from said terminal unit;
distribution interruption processing of interrupting the content distribution in response to a distribution interruption request received from said terminal unit and storing a distribution end position at the time that said distribution interruption request has been received; and
distribution resumption processing of deciding a distribution resumption position on the basis of said stored distribution end position when a distribution resumption request of the content of which the distribution is interrupted is received from said terminal unit and distributing the content from said distribution resumption position.

2. A content distribution method according to claim 1, wherein
said distribution start processing comprises selecting a distribution server which satisfies a predetermined condition for the terminal unit issuing said distribution start request from a plurality of distribution servers and instructing said distribution server to distribute the content; and
said distribution interruption processing comprises deciding said distribution end position on the basis of the fact that said distribution server receives said distribution interruption request from the terminal unit and storing said distribution end position;
said distribution resumption processing comprising selecting a distribution server which satisfies a predetermined condition for the terminal unit issuing said distribution resumption request from a plurality of distribution servers and instructing said distribution server to resuming-the content distribution.

3. A content distribution method according to claim 1, wherein
said distribution start processing comprises deciding a content to be distributed on the basis of user information and content information from said terminal unit; and
said distribution interruption processing comprises storing said distribution end position for each user information and content information from said terminal unit;
said distribution resumption processing comprising deciding the distribution resumption position from said stored distribution end position of the content on the basis of user information and content information from said terminal unit.

4. A content distribution method according to claim 3, wherein
said content information contains identification of the content and identification of software used for reproduction in said terminal unit and said distribution resumption processing comprises deciding said distribution resumption position of the content corresponding to said identification of the content and selecting the content corresponding to said identification of said software to distribute the content from said distribution resumption position.

5. A content distribution method according to claim 3, wherein
said content information contains identification of the content and a distribution rate at which the terminal unit can receive a content and said distribution resumption processing comprises deciding said distribution resumption position of the content corresponding to said identification of the content and distributing the content from said distribution resumption position at a rate based on said distribution rate.

6. A content distribution method according to claim 4, wherein
said user information includes group ID corresponding to one group and member identification indicating a plurality of members constituting said group; and
said distribution interruption processing stores the distribution end position of the content for each group ID;
said distribution resumption processing deciding the distribution resumption position on the basis of said group ID.

7. A content distribution method according to claim 6, wherein
master identification representing said group is established in said user information and said distribution interruption processing stores the distribution end position of the content in response to the distribution interruption request from said master identification.

8. A content distribution method according to claim 4, wherein
said user information includes group ID corresponding to one group and member identification indicating a plurality of members constituting said group; and
said distribution interruption processing stores the distribution end position for each of said group ID and said member identification;
said distribution resumption processing deciding the distribution resumption position for each of said group ID and said member identification.

9. A content distribution method according to claim 6, wherein
said distribution start processing and said distribution resumption processing make authentication for each group ID or for each member identification.

10. A content distribution apparatus for distributing a content from a distribution server through a network to a terminal unit, comprising:
a distribution server connected to said network; and
distribution control means for controlling said distribution server;
said distribution control means comprising:
distribution start means for deciding a content to be distributed in accordance with a distribution start request received from said terminal unit;
distribution end position storing means for storing a distribution end position of the content at the time that a distribution interruption request is received from said terminal unit;
resumption position decision means for deciding a distribution resumption position on the basis of said stored distribution end position when a distribution resumption request of the content of which the distribution is interrupted is received from said terminal unit; and
instructing means for instructing said distribution server to distribute the content decided by said distribution start means or said resumption position decision means.

11. A content distribution apparatus according to claim 10, wherein
a plurality of distribution servers are connected to said network and said instructing means includes selection means for selecting one of said plurality of distribution servers on the basis of a predetermined condition.

12. A content distribution apparatus according to claim 11, wherein
said distribution end position storing means stores said distribution end position for each of said user information and said content information received from said terminal unit and said resumption position decision means decides said distribution resumption position from said distribution end position stored in corresponding manner to said user information and said content information.

13. A content distribution apparatus according to claim 12, wherein
said content information contains content identification and software identification used for reproduction by the terminal unit and said instructing means selects the content corresponding to said content identification and said software identification.

14. A content distribution apparatus according to claim 12, wherein
said content information contains content identification and a distribution rate at which the terminal unit can receive a content and said instructing means selects the content in accordance with said content identification and selects a rate based on said distribution rate.

15. A content distribution apparatus according to claim 13, wherein
said user information includes group ID corresponding to one group and member identification indicating a plurality of members constituting said group; and
said distribution end position storing means stores the distribution end position of the content for each group ID;
said resumption position decision means deciding the distribution resumption position on the basis of said group ID of said distribution end position storing means.

16. A content distribution apparatus according to claim 15, wherein
master identification representing said group is established in said member identification and said distribution end position storing means stores the distribution end position of the content in response to the distribution interruption request having said master identification.

17. A content distribution apparatus according to claim 13, wherein
said user information includes group ID corresponding to one group and member identification indicating a plurality of members constituting said group; and
said distribution end position storing means stores the distribution end position for each of said group ID and said member identification;
said resumption position decision means deciding the distribution resumption position from contents stored in said distribution end position storing means on the basis of said group ID and said member identification.

18. A content distribution apparatus according to claim 15, wherein
said distribution control means includes authentication means for making authentication for each of said group ID or said member identification and permits operation of said distribution start means and said resumption position decision means on the basis of authentication result of said authentication means.
